(19) United States
(12) Patent Application Publication
(10) Pub. No.: US 2004/0041785 A1
(43) Pub. Date: Mar. 4, 2004

(54) Electronic paper methods and systems

(76) Inventors: Chad Stevens, Boise, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/231,796

(22) Filed: Aug. 29, 2002

(51) Int. Cl. G09G 3/34

(52) U.S. Cl. 345/107

(57) ABSTRACT

Electronic paper methods and systems are described. In accordance with one embodiment, an electronic paper driver is provided and is configured to receive a document in a first format from an application and convert the document in the first format to a second format that can be used for rendering a display on electronic paper.

### TECHNICAL FIELD

This invention relates to methods and systems for processing electronic paper.

### BACKGROUND

Electronic reusable paper is a display material that has many of the properties of paper. It stores an image, is viewed in reflective light, has a wide viewing angle, is flexible, and is relatively inexpensive. Unlike conventional paper, however, it is electrically writeable and erasable. Although projected to cost somewhat more than a normal piece of paper, a sheet of electronic reusable paper could be re-used thousands of times or more. This material has many potential applications in the field of information display including digital books, low-power portable displays, wall-sized displays, and fold-up displays.

There are a number of different technologies currently being developed in the area of electronic reusable paper. Xerox for example, in partnership with 3M, has created an e-paper called “Gyricon”. Lucent, in partnership with a company called E Ink, is working on a device (also called E Ink) that is expected to be available within the next few years.

Both of these technologies enable a black (or other color) and white display. Philips is working on a type of e-paper that will be full-color, but which is projected to be at least 10-15 years away.

The Gyricon version consists of a single sheet of transparent plastic, containing millions of tiny bichromal (i.e. two color) beads in oil-filled pockets. Text and other images are displayed through a rotation of the beads that occurs in response to an electrical impulse: a full rotation displays as black or white, and a partial rotation displays as gray shades. Like traditional paper, Gyricon has no, and needs no lighting component. For additional material on Gyricon and Xerox's electronic paper technology, the reader is referred to the following U.S. Pat. Nos. 6,396,621; 6,222,513; 6,162,321; and 6,128,124.

Lucent's E Ink device uses electronic ink and combines thin, plastic, flexible transistors with polymer LEDs (light-emitting diodes) to create what are called smart pixels. The process involved—which is not dissimilar to traditional printing processes—uses silicon rubber stamps to actually print tiny (as small as those for the Pentium III processor) computer circuits onto the surface. E Ink uses electronic ink for display: a liquid plastic substance consisting of millions of tiny capsules filled with light and dark dyes that change color—charged dye particles move either up or down within the capsules—when exposed to an electric charge. According to some, prototypes of the device have been running on watch batteries. The E Ink technology has been used for retail signs. For additional material on E Ink's technology, the reader is referred to the following U.S. Pat. Nos. 6,124,851; and 6,392,786.

Neither the Lucent/E Ink version, nor the Gyricon version require a constant power source. The initial charge creates the display, which then remains fixed until another charge is applied to change it. Low power demand is an important consideration for a technology that is intended to—at least partially—supplant a power-independent, standalone application like paper. The challenge involved in creating viable e-paper is to develop a material that has the desirable characteristics of traditional paper in addition to its own intrinsic benefits (such as being automatically refreshable). Like traditional paper, e-paper must be lightweight, flexible, glare-free, and affordable, if it is to gain consumer approval.

The challenges that emerging technologies face, particularly with emerging technologies with consumer appeal, is that of making products that incorporate such technologies truly ubiquitous and user friendly. That is, those products that will truly be successful are those products that are widely distributed and used by individual consumers, and which are easy and simple to use. Thus, for electronic paper to be widely accepted, applications that employ the electronic paper are going to need to be, from the ordinary consumer's standpoint, very simple to use.

Accordingly, this invention arose out of concerns associated with providing easy-to-use methods and systems that incorporate electronic paper.

### SUMMARY

Electronic paper methods and systems are described. In accordance with one embodiment, an electronic paper driver is provided and is configured to receive a document in a first format from an application and convert the document in the first format to a second format that can be used for rendering a display on electronic paper.

### BRIEF DESCRIPTION OF THE DRAWINGS

The same numbers are used throughout the drawings to reference like features and components.

FIG. 1 is a block diagram that illustrates various components in a system in accordance with one embodiment.

FIG. 2 is a block diagram showing exemplary components of a printing device in accordance with one embodiment.

FIG. 3 is a block diagram showing exemplary components of a client or host computer in accordance with one embodiment.

FIG. 4 is a perspective view of an exemplary system in accordance with one embodiment.

FIG. 5 is a block diagram that shows exemplary components associated with the FIG. 4 system.

FIG. 6 is a perspective view of an exemplary system in accordance with one embodiment.

FIG. 7 is a block diagram that shows exemplary components of a system in accordance with one embodiment.

FIG. 8 is a flow diagram that describes steps in a method in accordance with one embodiment.

### DETAILED DESCRIPTION

Overview

Methods and systems for facilitating the use of electronic paper are described. The described methods and systems provide a means by which a user can have their documents automatically converted into a renderable format for display on an electronic paper medium. Various implementations can be incorporated into a hard copy printer-either as a feature integrated with other printer features, or retrofitted onto an existing printer. The implementation can provide a transfer interface from a computing device, such as a personal computer, to the electronic paper media. Yet other implementations can provide a stand-alone device that can automatically convert documents into an electronic paper renderable format, e.g. a multifunction device that scans documents and automatically converts them into an electronic paper renderable format.

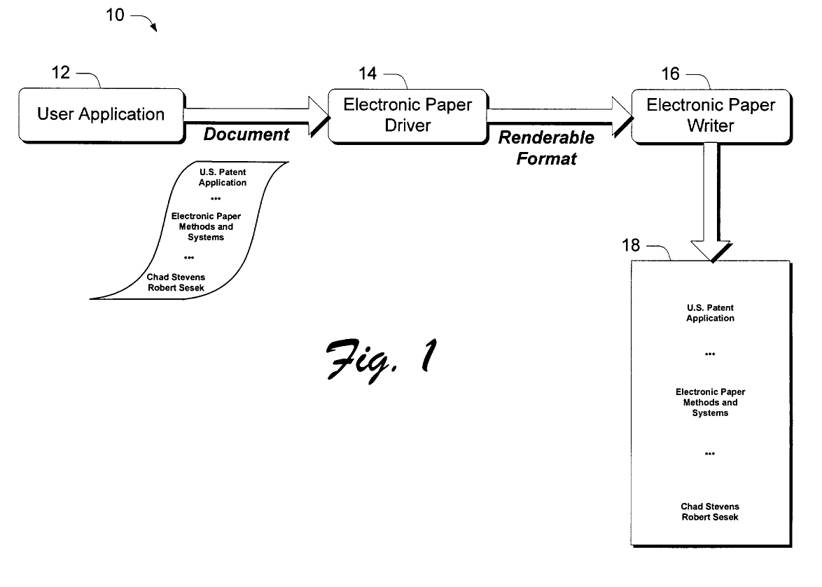

As an example, consider FIG. 1 that shows various components of a system 10 that can be employed to facilitate printing on electronic paper. System 10 comprises a user application 12 that can be used by a user to create a document for rendering on electronic paper. Application 12 typically resides on a user's computing device and can comprise any suitable type of application, examples of which include word processing applications, spreadsheet applications, email applications, computer-aided design applications and the like. System 10 further includes an electronic paper driver 14. The electronic paper driver can be implemented in any suitable hardware, software, firmware or combination thereof. The electronic paper driver functions to process the data comprising the user's document into a renderable format that can be used to render the data onto the electronic paper.

As an aside, recall from the discussion in the “Background” section, that there are, as of this date, a couple of different developing technologies that pertain to electronic paper. There will no doubt be in the future, other different attempts to further the technology that pertains to electronic paper. In as much as there are and will be different electronic paper technologies, there will no doubt be different renderable formats associated with these different technologies. Accordingly, the illustrated electronic paper driver is not intended to be limited to any one particular present or future electronic paper technology. Rather, the electronic paper driver 14 is intended to illustrate a layer whose function it is to convert document formats into renderable formats that can be utilized to render a user's document on electronic paper.

As an analogy, consider printer drivers. A printer driver is a software program that interacts with a particular printing device. The printer driver contains the special knowledge of the device or special software interface that programs using the driver do not. In personal computers, a driver is often packaged as a dynamic link library (DLL) file. A printer driver essentially converts the more general input/output instructions of an operating system to messages that the device type, or in this example—the printer—can understand. So, for example, a printer driver can produce, from application data, a list of instructions or commands, such as those that are defined in terms of Printer Control Language (PCL). These instructions are then used by the printer to render a document on a print medium.

Conceptually similar to a printer driver, the illustrated electronic paper driver 14 functions to convert the document format or data associated with a user's document, into a format that is understood by hardware, software and/or firmware that performs the actual rendering process on the electronic paper. Accordingly, system 10 includes an electronic paper writer 16 that processes the output of the electronic paper driver 14 to render the data associated with the user's document onto the electronic paper, illustrated generally at 18.

In the systems mentioned in the “Background” section, writing to the electronic paper can occur via the provision of electrical impulses or charges. To assist in understanding various principles that can be associated with electronic paper writer 16, the reader is referred to U.S. Pat. Nos. 6,303,211 and 6,262,707, the disclosures of which are incorporated by reference herein, which discuss various addressing systems that can be used to address electronic paper locations and hence render an image on the electronic paper. The '707 patent is a particularly interesting reference insofar as it discusses various different addressing approaches.

The illustrated electronic paper driver 14 and electronic paper writer 16 can reside in any suitable system and at any suitable location within a system. For example, the functionality of the electronic paper driver 14 can reside on a host device or computer, such as the user's laptop computer. Alternately or additionally, the electronic paper driver 14 can reside on the device that performs the actual rendering on the electronic paper.

The electronic paper writer 16 can reside as part of a printer or printing device that includes other printing capabilities such as laser and ink jet capabilities. Alternately or additionally, the electronic paper writer can reside as a stand-alone device that is dedicated to printing on electronic paper. Alternately or additionally, the electronic paper writer can reside as part of a multi-function printing device.

Exemplary Printing Device Embodiment

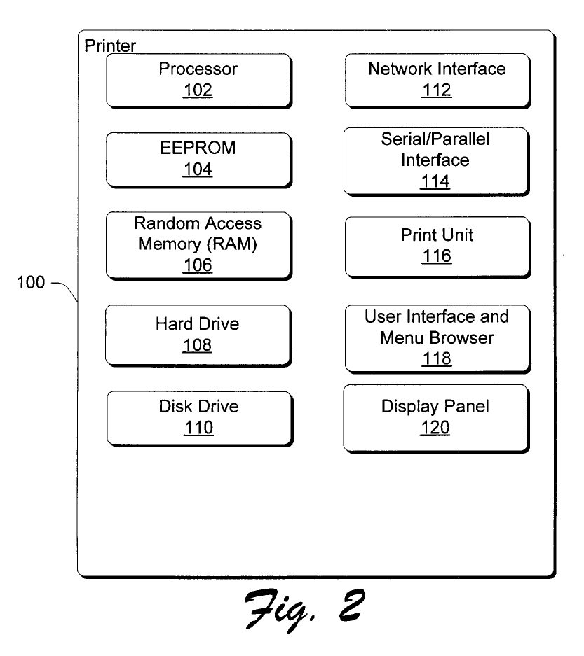

FIG. 2 is a block diagram showing exemplary components of a printing device in the form of a printer 100 that can be used in accordance with the described embodiments. While FIG. 1 illustrates a specific type of printing device, it should be appreciated that other printing devices such as facsimile machines, copiers, and the like can be utilized without departing from the spirit and scope of the claimed subject matter. In addition, the term “printer” or “printing device” as used in this document will be understood to include multifunction devices that, in addition to printing, perform additional functions. Such additional functions can include, without limitation, one or more of the following: faxing, copying, scanning and the like.

Printer 100 includes a processor 102 and at least one computer-readable media. In this example, the computer readable media can include an electrically erasable programmable read-only memory (EEPROM) 104 and a random access memory (RAM) 106. Further, the computer-readable media can include hard drive 108. Processor 102 processes various instructions necessary to operate the printer 100 and communicate with other devices. EEPROM 104, RAM 106, and/or hard drive 108 can store various information such as configuration information, fonts, templates, data being printed, and menu structure information.

In addition, although not shown in FIG. 2, a particular printer may also contain a ROM (non-erasable) in place of or in addition to EEPROM 104. Furthermore, a printer may alternatively contain a flash memory device in place of or in addition to EEPROM 104.

Printer 100 can also include a disk drive 110, a network interface 112, and a serial/parallel interface 114. Disk drive 110 provides additional storage for data being printed or other information used by the printer 100. Although both RAM 106 and disk drive 110 are illustrated in FIG. 2, a particular printer may contain either RAM 106 or disk drive 110, depending on the storage needs of the printer. For example, an inexpensive printer may contain a small amount of RAM 106 and no disk drive 110, thereby reducing the manufacturing cost of the printer. Network interface 112 provides a connection between printer 100 and a data communication network. Network interface 112 allows devices coupled to a common data communication network to send print jobs, menu data, and other information to printer 100 via the network. The network interface can be embodied as a network server and, more particularly, as a Web server. As a network server or Web server, the network interface can enable a user to access the printer using standard network protocols. For example, as a Web server, the network interface can enable two-way communication with one or more clients via standard network protocols such as TCP/IP.

Serial/parallel interface 114 can also provide a data communication path directly between printer 100 and another device, such as a workstation, server, or other computing device. Although the printer 100 shown in FIG. 2 has two interfaces (network interface 112 and serial/parallel interface 114), a particular printer may only contain one interface.

Printer 100 also includes a print unit 116. In this example, the print unit can include an electronic paper writer such as electronic paper writer 16 (FIG. 1). The print unit 116 can also include other mechanisms that are arranged to selectively apply ink (e.g., liquid ink, toner, etc.) to a print media (e.g., paper, plastic, fabric, etc.) in accordance with print data within a print job. Thus, for example, print unit 116 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner. Print unit 116 can also be configured to support duplex printing, for example, by selectively flipping or turning the print media as required to print on both sides.

The print unit 116 can also comprise an ink jet print unit that utilizes principles of ink jet printing. Those skilled in the art will recognize that there are many different types of print units available, and that for the purposes of the present discussion, print unit 116 can include any of these various types.

Printer 100 can also contain a user interface/menu browser 118 and a display panel 120. User interface/menu browser 118 allows the user of the printer to navigate the printer's menu structure. User interface 118 may be a series of buttons, switches or other indicators that are manipulated by the user of the printer. Display panel 120 is a graphical display that provides information regarding the status of the printer and the current options available through the menu structure.

The illustrated printer can, and typically does include software that provides a runtime environment in which software applications or applets can run or execute. The runtime environment can facilitate the extensibility of the printer by allowing various interfaces to be defined that, in turn, allow applications or applets to interact with the printer in more robust manners. The printer can, but need not include, as part of its software applications, an electronic paper driver such as the one shown at 14 and described above in FIG. 1.

It will be appreciated that the inventive techniques and methods described herein include all forms of computer-readable media when such media contains instructions which, when executed by a processor or computer, implement the techniques and methods.

Exemplary Client

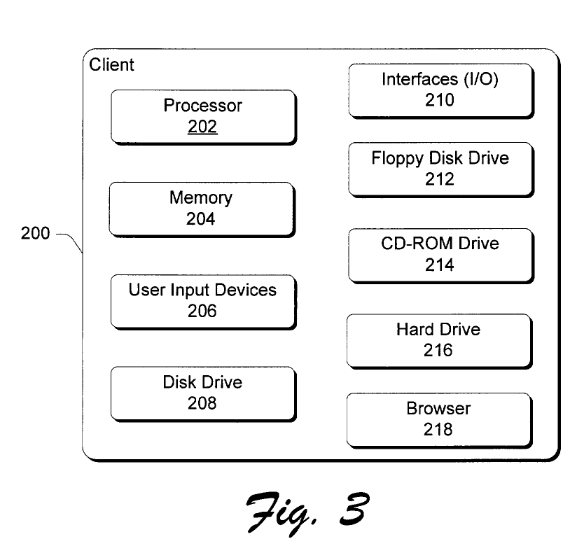

FIG. 3 is a block diagram showing exemplary components of an exemplary client or host computer 200. Computer 200 includes a processor 202, a memory 204 (such as ROM and RAM), user input devices 206, a disk drive 208, interfaces 210 for inputting and outputting data, a floppy disk drive 212, and a CD-ROM drive 214.

Processor 202 performs various instructions to control the operation of computer 200. Memory 204, disk drive 208, and floppy disk drive 212, CD-ROM drive 214 and a hard drive 216 can provide data storage mechanisms. User input devices 206 includes a keyboard, mouse, pointing device, or other mechanism for inputting information to computer 200. Interfaces 210 provide a mechanism for computer 200 to communicate with other devices. Client 200 can also include a browser 218 that can allow a user to browse the Web. Exemplary browsers can include Microsoft's Internet Explorer or Netscape's Navigator.

Computer 200 can also include, as part of its software, one or more electronic paper drivers, such as the one shown and described at 14 (FIG. 1).

Exemplary Systems

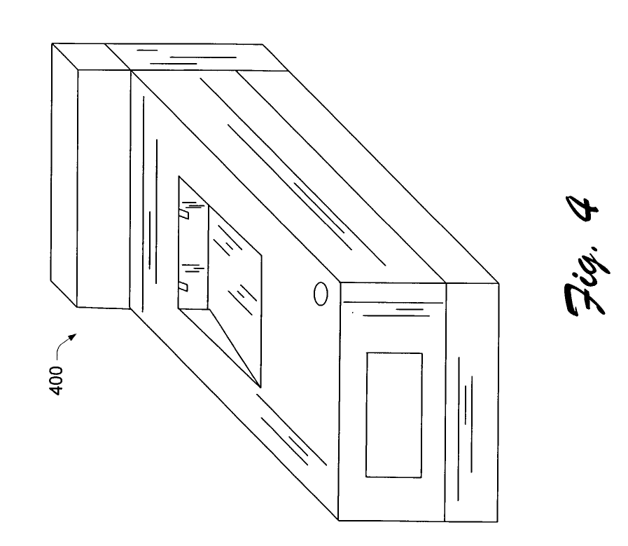

FIG. 4 shows but one exemplary system 400 in accordance with one embodiment. In this example, system 400 comprises a desktop printer that embodies functionality that enables it to render an image on electronic paper. In this example, the printer embodies the hardware and software that functions to render an image on electronic paper. This printer can comprise a stand alone electronic paper printer. Alternately, the printer can embody functionality that permits it to function as not only an electronic paper printer, but a conventional printer (i.e. laser or ink jet printer) as well.

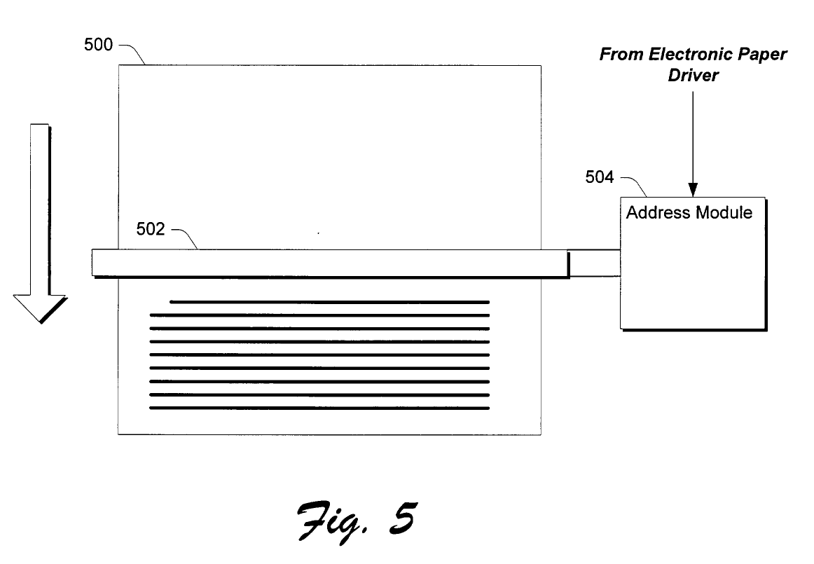

More specifically, FIG. 5 shows exemplary components that are located internally of printer 400 that facilitate the image rendering process on the electronic paper. The illustrated components can comprise part of the printer's print unit (such as print unit 116 in FIG. 2). In the illustrated example, a single piece of electronic paper 500 is illustrated disposed under a charge transfer bar 502. The charge transfer bar functions to transfer charge onto the electronic paper and thus, effectively transfers an image onto the electronic paper. Here, a portion of the image that has been transferred on the lower part of the electronic paper consists of a paragraph of text, illustrated by the lines that appear across the electronic paper. In the example, the electronic paper is about half way through the rendering process. An address module 504 is provided and is connected to the charge transfer bar. The address module receives input from the electronic paper driver and uses that input to address locations on the charge transfer bar to selectively apply charge to the electronic paper. It is to be appreciated and understood that the system of FIG. 5 constitutes but one system that can be used to render an image on the electronic paper. Other systems can be used without departing from the spirit and scope of the claimed subject matter.

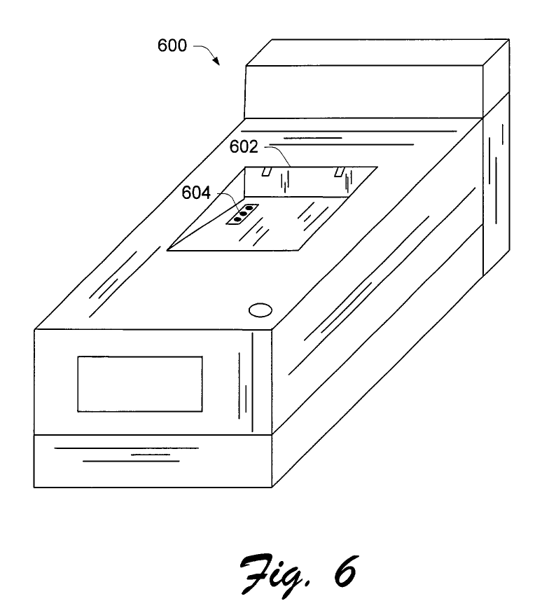

FIG. 6 illustrates another exemplary system 600 that can be utilized to render images on electronic paper. Here, system 600 comprises a printer having an output bin 602. An electronic paper connector 604 is provided on the printer and serves as a connection or port that can be used to connect an electronic paper writer (such as writer 16) so that the printer can be used to render images on the electronic media.

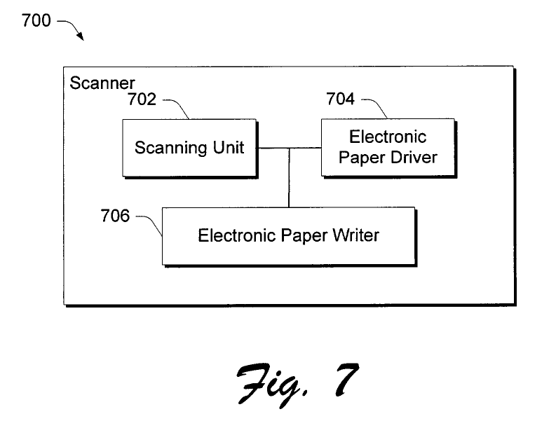

FIG. 7 illustrates another exemplary system 700 that can be utilized to render images on electronic paper. Here, system 700 comprises a scanner having a scanning unit 702, an electronic paper driver 704 and an electronic paper writer 706. In this example, the scanning unit receives and scans a document that is intended to be rendered on electronic paper. The scanning unit is connected to the electronic paper driver 704 which effectively converts the scanned data produced by scanning unit 702 into data that can be used to drive the electronic paper writer 706. The electronic paper writer is then used to process the data received from the electronic paper driver into a form in which it can be used to render an image onto the electronic paper. But one way of rendering an image onto the electronic paper is discussed above in connection with the charge transfer bar 502 of FIG. 5. Other ways can be utilized without departing from the spirit and scope of the claimed subject matter.

Exemplary Methods

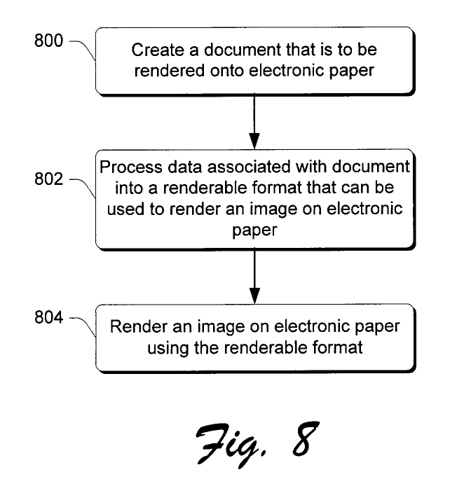

FIG. 8 is a flow diagram that illustrates steps in a method in accordance with one embodiment. The method can be implemented in any suitable hardware, software, firmware or combination thereof. In the illustrated example, the method can be implemented using, among other systems, any of the above-described systems.

Step 800 creates a document that is to be rendered onto electronic paper. This step can be implemented in any suitable way. In one embodiment, the method is implemented via a software application examples of which are given above. In this example, the created document is in electronic form and can reside, for example, on a user's computer. Alternately or additionally, this step can be implemented by creating a hard copy output. Step 802 processes data associated with the document into a renderable format that can be used to render an image on electronic paper. In one embodiment, this step can be implemented by electronic paper driver software that automatically converts data associated with the document into a format that can be understood and used by other software, hardware and/or firmware to actually render an image on the electronic paper. Exemplary electronic paper drivers can reside at any suitable location in a system in which rendering on the electronic paper takes place. For example, the driver can reside on a host computer or on a rendering device (such as an electronic paper printer, a printer, scanner and/or multifunction device).

Step 804 renders an image on electronic paper using the renderable format. This step can be implemented in any suitable way. In the above example, this step is implemented by an electronic paper writer that is in communication with the electronic paper driver. The electronic paper writer functions, in the above examples, to provide a suitable charge at a suitable location on the electronic paper so that an image can be formed.

Conclusion

Various methods and systems described above facilitate the use of electronic paper. The described methods and systems provide a means by which a user can have their documents automatically converted into a renderable format for display on an electronic paper medium. By having documents automatically converted into a renderable format for display on the electronic paper, the user is relieved of the need to get involved in the conversion process.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

We claim:

1. A system comprising:
an electronic paper driver configured to:
receive a document in a first format from an application; and
convert the document in the first format to a second format that can be used for rendering a display on electronic paper.

2. The system of claim 1, wherein the electronic paper driver is embodied in a document printer.

3. The system of claim 1, wherein the electronic paper driver is embodied in a document printer, the document printer comprising a dedicated electronic paper printer.

4. The system of claim 1, wherein the electronic paper driver is embodied on a host computer.

5. The system of claim 1, wherein the electronic paper driver is embodied in a scanner.

6. A computer readable medium embodying the electronic paper driver of claim 1.

7. A system comprising:
a software application configured to create a document for rendering on electronic paper;
an electronic paper driver associated with the software application and configured to:
receive a document in a first format from the software application, and
convert the document in the first format to a second format that can be used for rendering a display on electronic paper;
an electronic paper writer associated with the electronic paper driver and configured to process data associated with the second format for rendering a display on electronic paper.

8. The system of claim 7, wherein the software application and electronic paper driver are embodied on a common computing device.

9. The system of claim 7, wherein the electronic paper driver and electronic paper writer are embodied on a common computing device.

10. A system comprising:
an electronic paper driver configured to receive a document in a first format from an application and convert the document in the first format to a second format that can be used for rendering a display on electronic paper;
charge transfer means associated with the electronic driver and configured to transfer charge onto electronic paper for transferring an image associated with the second format onto the electronic paper; and
an address module associated with the charge transfer means and configured to cause the charge transfer means to selectively apply charge to the electronic paper.

11. The system of claim 10, wherein the charge transfer means comprises a charge transfer bar.

12. A method comprising:
receiving a document that is to be rendered onto electronic media; and
processing, with an electronic paper driver, data associated with the document into a renderable format that can be used to render an image on electronic paper.

13. The method of claim 12, wherein said act of receiving comprises receiving the document from a software application executing on a user's computing device.

14. The method of claim 12, wherein said act of receiving comprises receiving a hard copy output.

15. The method of claim 12 further comprising prior to said act of receiving, creating the document.

16. The method of claim 12 further comprising prior to said act of receiving, creating the document, said acts of creating, receiving and processing being performed by a host computer.

17. The method of claim 12 further comprising after said act of processing, using said renderable format to render an image on electronic paper.

18. The method of claim 12, wherein said acts of receiving and processing are performed by a host computer.

19. The method of claim 12, wherein said acts of receiving and processing are performed by a rendering device.

20. The method of claim 12, wherein said acts of receiving and processing are performed by a scanner.
